(19) United States
(12) Patent Application Publication
(10) Pub. No.: US 2005/0131614 A1
(43) Pub. Date: Jun. 16, 2005

(54) Vehicle driving system and method

(75) Inventors: Akira Isogai, Anjo-city (JP); Eiji Teramura, Okazaki-city (JP)

Correspondence Address: HARNESS, DICKEY & PIERCE, P.L.C., P.O. BOX 828, BLOOMFIELD HILLS, MI, 48303, US

(73) Assignee: DENSO Corporation

(21) Appl. No.: 11/009,990

(22) Filed: Dec. 10, 2004

(30) Foreign Application Priority Data
Dec. 12, 2003 (JP) 2003-415335
Oct. 21, 2004 (JP) 2004-307360

(51) Int. Cl. G05D 1/00; G06F 7/00

(52) U.S. Cl. 701/93; 701/96

(57) ABSTRACT

When a drive control operation is set, a vehicle driving system sets a travel speed of a vehicle as a target travel speed, stores it as a set travel speed and starts drive control of the vehicle. When the drive control operation is resumed, the vehicle driving system compares the set travel speed stored in a memory and a recommended speed of a road on which the vehicle is traveling. When the recommended speed is smaller than the set travel speed and a speed limit change flag is kept reset, the vehicle driving system sets the recommended speed as the target travel speed, and restarts the drive control of the vehicle. When the recommended speed is larger than the set travel speed and at the same time the speed limit change flag is kept reset, the vehicle driving system sets the set travel speed as the target travel speed, and restarts the drive control of the vehicle.

### CROSS REFERENCE TO RELATED APPLICATION

This application is based on and incorporates herein by reference Japanese Patent Applications No. 2003-415335 filed Dec. 12, 2003 and No. 2004-307360 filed Oct. 21, 2004.

### FIELD OF THE INVENTION

The present invention relates to a vehicle driving system and method that performs drive control of a vehicle according to a target travel speed.

### BACKGROUND OF THE INVENTION

Conventionally, a system that performs a drive control such as a cruise control of a vehicle according to a set target travel speed is known. Such a system operates in two operation modes: a set mode of newly setting a target travel speed and starting drive control of a vehicle according to the set target travel speed; and a resume mode of reading the target travel speed having been set in the set mode and restarting the drive control of a vehicle according to the read target travel speed.

Once a driver has set the target travel speed in the set mode, the driver can restart the drive control with the already set target travel speed by using the resume mode next time and later rounds without newly setting a target travel speed again.

However, with the conventional system, the drive control may be restarted at an inappropriate target travel speed. For example, suppose that a driver sets a high target travel speed and makes the system control driving of the vehicle while the automobile is traveling on a highway at a high speed. When the driver restarts the drive control by the resume mode due to the driver's misunderstanding or misapprehension after the vehicle left the highway to be on an ordinary road, the drive control of the vehicle will be restarted with the high target travel speed having been set during highway running.

Moreover, for example, when the driver starts or restarts the drive control in the set mode or in the resume mode without noticing a change in a speed limit of a road on which the vehicle is traveling, the drive control is not performed with a target travel speed matching the speed limit of the road.

### SUMMARY OF THE INVENTION

This invention has an object to provide a vehicle driving system and method capable of starting or restarting the drive control of a vehicle with an appropriate target travel speed.

A vehicle driving system and method of this invention acquires a travel speed recommended in a road on which the vehicle is traveling. When the drive control of the vehicle is restarted in the resume mode, the vehicle driving system compares the target speed having been set in the set mode with a recommended travel speed, and sets the smaller speed as a target speed used for performing the drive control of the vehicle. Accordingly, for example, even in the case where the drive control of a vehicle was performed using the set mode during highway running and subsequently the drive control in the resume mode is restarted during ordinary road running due to the driver's misunderstanding or misapprehension, and when the already set target speed is larger than a recommended travel speed in the road, the drive control of the vehicle is restarted with the recommended travel speed. That is, the drive control of a vehicle can be restarted with an appropriate target speed.

Moreover, when the drive control of a vehicle is started or restarted either in the set mode or in the resume mode, the vehicle driving system determines a difference between a road attribute of the road on which the vehicle was traveling at the time of performing the drive control of the vehicle last time and a road attribute of the road on which the vehicle is traveling at the time of starting or restarting the drive control of the vehicle this time.

Further, when the road attributes are different, the vehicle driving system compares the target speed being set this time or the target speed having been set in the set mode with the recommended travel speed included in the road attributes, and sets the smaller speed as the target speed used for performing the drive control of the vehicle. Thereby, even in the case where the driver starts or restarts the drive control of a vehicle in the set mode or in the resume mode, being not conscious of a change in the speed limit of the road on which the vehicle is traveling, and when the target speed being set this time or the target speed having been set in the set mode is larger than the recommended travel speed, the drive control of the vehicle is started or restarted with the recommended travel speed. That is, the drive control of the vehicle can be started or restarted with an appropriate target speed.

Still Further, even if, for example, the drive control of a vehicle was performed using the set mode during highway running and subsequently the driver directs the vehicle driving system to start or restart the drive control in the resume mode during ordinary road running due to the driver's misunderstanding or misapprehension, the vehicle driving system prohibits the restart of the drive control of the vehicle because the road attributes changed. Thereby, it is possible to prevent the drive control of the vehicle from being restarted according to an inappropriate target speed.

### BRIEF DESCRIPTION OF THE DRAWINGS

The above and other objects, features and advantages of the present invention will become more apparent from the following detailed description made with reference to the accompanying drawings. In the drawings:

FIG. 1 is a block diagram showing a vehicle driving system in a first embodiment of this invention;

FIG. 2 is a schematic view showing a button and a lever provided in an operation switch in the first embodiment;

FIG. 3 is a flowchart of a process in which the vehicle driving system performs the drive control of a vehicle in the first embodiment;

FIG. 4 is a flowchart of a process in which the vehicle driving system determines the operation content of an operation switch in the first embodiment;

FIG. 5 is a flowchart of a process in which the vehicle driving system sets various settings related to the drive control of the vehicle in the first embodiment;

FIG. 6 is a flowchart of a process in which the vehicle driving system adjusts the target travel speed in the first embodiment;

FIG. 7 is a flowchart of a process in which the vehicle driving system sets various settings related to the drive control of the vehicle in a second embodiment of this invention;

FIG. 8 is a flowchart of a process in which the vehicle driving system sets various settings related to the drive control of the vehicle in a third embodiment of this invention;

FIG. 9 is a flowchart of a process in which the vehicle driving system sets various settings related to the drive control of the vehicle in a fourth embodiment of this invention;

FIG. 10 is a flowchart of a process in which the vehicle driving system sets various settings related to the drive control of the vehicle in a fifth embodiment of this invention; and

FIG. 11 is a flowchart of a process in which the vehicle driving system of sets various settings related to the drive control of the vehicle in a sixth embodiment of this invention.

### DETAILED DESCRIPTION OF THE PREFERRED EMBODIMENT

### First Embodiment

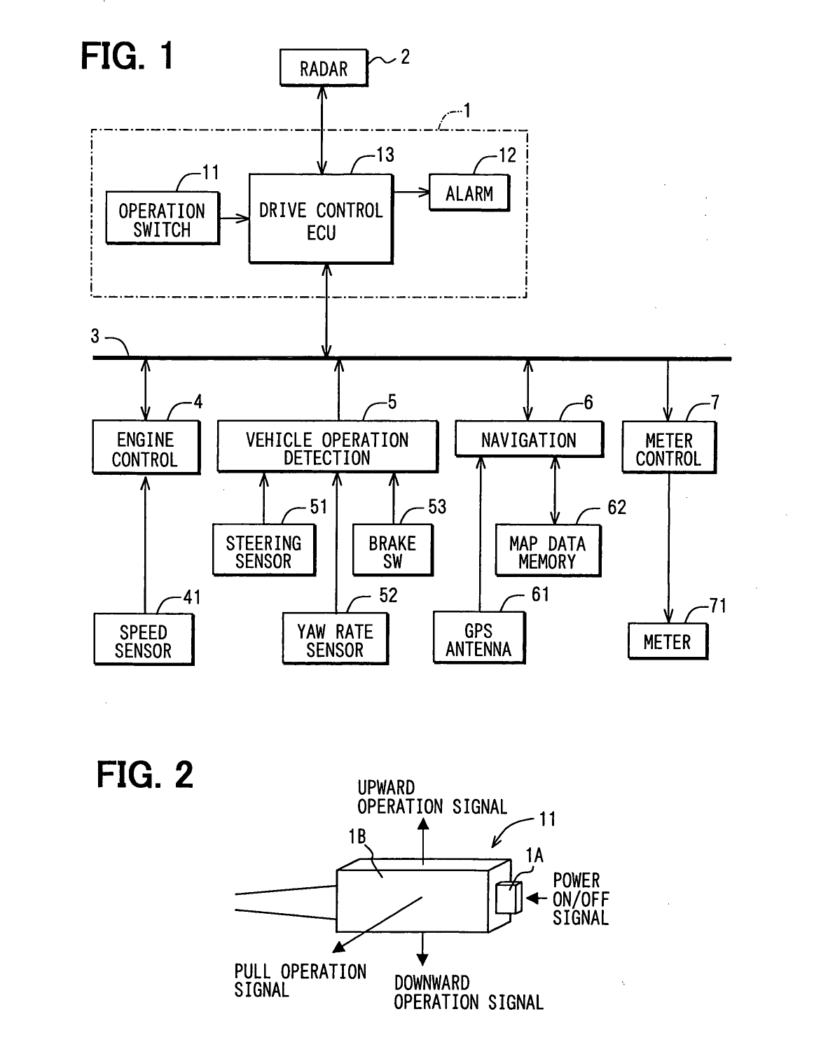

Referring first to FIG. 1, a vehicle driving system 1 is connected with a radar device 2 for detecting other vehicle traveling in front of the vehicle. Moreover, through an in-vehicle LAN 3 provided in the vehicle, the vehicle driving system 1 is connected with an engine control system 4 for controlling a engine of the vehicle, a vehicle operation detecting device 5 for detecting an operating status of the vehicle, a car navigation apparatus 6 for performing various navigation operations, and a meter control device 7 for controlling the operation of a meter 71. Communication between the vehicle driving system 1 and each apparatus/device is performed according to a CAN communication protocol.

The radar device 2 is made up of, for example, a millimeter wave transceiver, transmits a millimeter wave of a predetermined frequency ahead of the vehicle, and receives a reflected wave reflected from the other vehicle that is traveling in front of the vehicle and irradiated by the millimeter wave. Then, based on a phase difference between the transmitted millimeter wave and the received reflected wave and an attenuation level, a relative distance and relative direction or bearing to the other vehicle traveling in front of the vehicle are measured. A relative distance and relative direction to the other vehicle traveling in front of the vehicle may be measured using an ultrasonic wave or a laser.

A speed sensor 41 is for detecting rotation of a wheel, and calculates the travel speed from the number of revolution of a wheel of the vehicle. A travel speed of the vehicle may be calculated based on an output of an acceleration sensor for detecting acceleration of the vehicle or an axle sensor for detecting rotation of the axle of the vehicle.

The engine control system 4 is equipped with a CAN communication circuit and controls the engine of the vehicle by adjusting the opening of a throttle valve and shifting a transmission based on a position signal from an accelerator pedal, an engine speed from the engine rotation sensor, and the travel speed of the vehicle. Moreover, the engine control system 4 transmits a travel speed of the vehicle calculated by the speed sensor 41 and the engine speed from the engine rotation sensor to the vehicle driving system 1.

Once the engine control system 4 has acquired the drive-control-start signal from the vehicle driving system 1, the engine control system 4 performs engine control of the vehicle according to a control signal transmitted from the vehicle driving system 1 after that. When having acquired a drive-control-termination signal from the vehicle driving system 1, the engine control system 4 will perform engine control of the vehicle again based on the position signal of the accelerator pedal etc.

A steering sensor 51 is equipped with, for example, a plurality of mechanical gears, and measures the steering angle of a steering wheel of the vehicle based on the number of revolution of the gears. The steering angle of the steering may be measured using an infrared ray or a laser.

A yaw rate sensor 52 is equipped with, for example, a gyro sensor and detects the yaw angular velocity (rotation angular velocity) of the vehicle based on an output of the gyro sensor. The yaw angular velocity may be detected based on an output from an earth magnetism sensor.

A brake pedal switch 53 consists of, for example, a switching sensor for detecting a contact, detects whether a brake pedal of the vehicle is depressed, and outputs a brake status signal. Detection of whether the brake pedal of the vehicle is depressed may be done by using a non-contact type sensor that uses a laser, etc.

A vehicle operation detecting device 5 is equipped with a CAN communication circuit and transmits the steering angle of the steering measured by the steering sensor 51, the yaw angular velocity detected by the yaw rate sensor 52, and the brake status signal outputted from the brake pedal switch 53 to the vehicle driving system 1. Other signals than these signals, such as traveling acceleration of the vehicle, may be transmitted to the vehicle driving system 1.

A GPS antenna 61 is a small vehicle-mounted antenna for receiving a GPS signal for location measurement transmitted from a GPS Satellite that is an artificial satellite.

A map data memory 62 is made up of, for example, a hard disk drive, stores map information including road information, building information, address information of zones, postal code number information, etc. as the map data, and also stores image data for map image display. Furthermore, the map data memory 62 stores speed limits of roads in urban areas and the travel speeds that are recommended in performing the drive control of the vehicle on the respective roads (recommended travel speeds). These pieces of data may be stored in CD-ROM, DVD-ROM, etc.

The car navigation apparatus 6 calculates the longitude and latitude of a point where the vehicle is traveling (present location of the vehicle) from the GPS signal received by the GPS antenna 61 and performs various navigation operations. Specifically, the car navigation apparatus 6 reads map image data from the map data memory 62, generates a map image such that a mark indicating the vehicle is superimposed on the map data, and performs navigation display. Moreover, the car navigation apparatus 6 identifies a road on which the vehicle is traveling from the calculated location of the vehicle, reads the speed limit and recommended travel speed in the road from the map data memory 62, and transmits them to the vehicle driving system 1.

Moreover, when receiving the travel speed of the vehicle, the car navigation apparatus 6 also overwrites the recommended travel speed stored in the map data memory 62 with the travel speed of the vehicle as a recommended travel speed of the road on which the vehicle is traveling. The latter recommended travel speed is determined in advance based on the speed limit, and stored in the map data memory 62.

The meter control device 7 acquires the vehicle speed signal indicating the travel speed of the vehicle and the engine speed signal indicating the rotational speed of the engine, and makes the meter 71 operate according to them, and thereby notifies the driver of the travel speed and the engine speed of the vehicle.

The vehicle driving system 1 has two operation modes, the set mode and the resume mode, and performs the drive control of the vehicle by one of the operation modes.

An operation switch 11, as shown in FIG. 2, is a switch equipped with a lever 1B added with a main button 1A. When the main button 1A is pressed, power ON and power OFF signals will be outputted alternately. Moreover, when the lever 1B is bowed upward, an upward operation signal will be outputted; when it is bowed downward, a downward operation signal will be outputted. When it is bowed toward the driver, a pull operation signal is outputted. The outputs of the operation signals may be outputted by a remote controller equipped with a cursor key or the like.

An alarm 12 has, for example, a buzzer, and outputs an alarm tone from the buzzer. The alarm tone may be outputted from speakers of audio system etc. mounted on the vehicle.

A drive control ECU 13 performs the drive control of the vehicle by determining a travel speed that is a target in performing the drive control of the vehicle (hereinafter referred to as target travel speed) and the adjustment of the target travel speed during the drive control of the vehicle, etc., based on a drive control flag stored in internal memory of the ECU, an operation signal outputted from the operation switch 11, and a relative distance and relative direction that are outputted from the radar device 2.

Specifically, in the case where the drive control flag is kept reset (no cruise drive control), when the ECU 13 acquires the downward operation signal from the operation switch 11, the drive control ECU 13 will determine that a set operation was done, and start the drive control of the vehicle in the set mode. That is, the drive control ECU 13 transmits the drive control start signal to the engine control system 4, and receives the travel speed of the vehicle received from the engine control system 4.

Next, the drive control ECU 13 transmits the received travel speed of the vehicle to the car navigation apparatus 6, and makes the car navigation apparatus 6 overwrite the recommended travel speed of the road on which the vehicle is traveling that is stored in the map data memory 62 with the travel speed of the vehicle.

Furthermore, the drive control ECU 13 stores the received travel speed of the vehicle in the internal memory as a set travel speed, determines the received travel speed of the vehicle as the target travel speed, and generates control signals for adjusting opening of a throttle valve and for shifting the transmission so that the travel speed of the vehicle received from the engine control system 4 agrees with the target travel speed. Further, it transmits the generated control signal to the engine control system 4, and starts the drive control of the vehicle.

In the case where the drive control flag is kept reset, when the upward operation signal is acquired from the operation switch 11, the drive control ECU 13 determines that a resume operation was done, and restart the drive control of the vehicle in the resume mode. In this situation, the drive control ECU 13 transmits the drive control start signal to the engine control system 4, reads the set travel speed from an internal memory, and receives a recommended travel speed from the car navigation apparatus 6.

Next, the drive control ECU 13 compares the acquired set travel speed with the recommended travel speed. When the set travel speed is smaller than the recommended travel speed, it determines the set travel speed as the target travel speed. On the other hand, when the recommended travel speed is smaller than the set travel speed, the drive control ECU 13 reads a speed limit change flag from the internal memory.

It should be noted that in the above two cases (case 1: the set travel speed is smaller than the recommended travel speed; and case 2: the recommended travel speed is smaller than the set travel speed) are referred to, omitting an similar case just for simplicity, and that the equal case may be included in either of the two cases. Further, when the flag is kept set, the drive control ECU 13 determines the recommended travel speed as the target travel speed; when the flag is kept reset, it determines the set travel speed as the target travel speed.

The drive control ECU 13 generates the control signals for adjusting the opening of the throttle valve and for shifting the transmission so that the target travel speed determined by the above procedure agrees with the travel speed of the vehicle outputted from the engine control system 4, transmits it to the engine control system 4, and restarts the drive control of the vehicle.

On the other hand, in the case where the drive control flag is kept set (in cruise drive control), when the upward operation signal is acquired from the operation switch 11, the drive control ECU 13 determines that an acceleration operation was done and will increase the target travel speed by a predetermined amount. In that case, when the downward operation signal is acquired from the operation switch 11, the drive control ECU 13 determines that a deceleration (coasting) operation was done and will decrease the target travel speed by a predetermined amount.

Moreover, in the case where the drive control flag is kept set, when the drive control ECU 13 acquires the pull operation signal from the operation switch 11 or determines that the brake pedal was depressed from a brake status signal received from the vehicle operation detecting device 5, the drive control ECU 13 transmits the drive-control-termination signal to the engine control system 4 and resets the drive control flag.

The drive control ECU 13 directs the alarm 12 to output the alarm tone in addition to the above operations related to the drive control of the vehicle. Specifically, when the drive control ECU 13 determines that the vehicle and the other vehicle will come closer than the predetermined distance from the relative distance to other vehicle traveling in front of the vehicle and the relative direction to them received from the radar device 2 and the steering angle of the steering and the yaw angular velocity received from the vehicle operation detecting device 5, it directs the alarm 12 to output the alarm tone.

Furthermore, the drive control ECU 13 always monitors the speed limit of the road on which the vehicle is traveling that is transmitted by the car navigation apparatus 6. When the above speed limit changes, the drive control ECU 13 will set the speed limit change flag stored in the internal memory. The flag is reset at the time of start and restart of the drive control of the vehicle.

In addition, the drive control ECU 13 generates the speed signal indicating the travel speed of the vehicle and the engine speed signal indicating the engine speed, and transmits them to the meter control device 7. When the operation switch 11 outputs power ON and power OFF signals, the drive control ECU 13 will turn on and off the power source of the vehicle driving system 1, respectively.

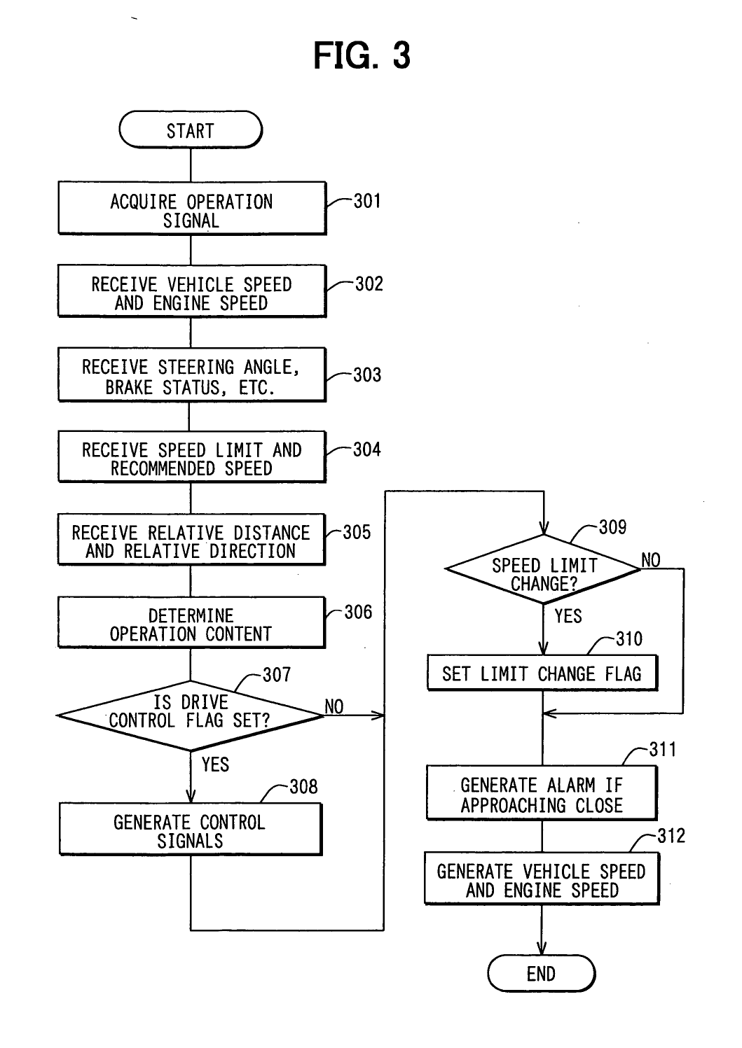

The drive control ECU 1 is programmed to execute a control process shown in FIGS. 3 to 6. This process is executed for every predetermined time.

At step 301, the drive control ECU 13 acquires the operation signal outputted from the operation switch 11. At step 302, the travel speed and the engine speed of the vehicle are received from the engine control system 4. At step 303, the steering angle of the steering, the yaw angular velocity, and the brake status signal are received from the vehicle operation detecting device 5. At step 304, the speed limit of the road on which the vehicle is traveling and the recommended travel speed are received from the car navigation apparatus 6. At step 305, the relative distance to the other vehicle traveling in front of the vehicle and the relative direction to it are received from the radar device 2.

At step 306, an operation content determining process of determining the operation content of an operation signal acquired at step 301 is performed. The details of the process in this step will be described later.

At step 307, whether the drive control flag stored in the internal memory is kept set is determined. When the drive control flag is kept set, the processing proceeds to step 308, where the control signals for adjusting the opening of the throttle valve and for shifting the transmission is generated so that the travel speed of the vehicle received at step 302 agrees with the target travel speed, and transmits them to the engine control system 4. When the drive control flag is kept reset, the processing proceeds to step 309.

At step 309, whether the speed limit received at step 304 of the road on which the vehicle is driving changed is determined. When the speed limit of the road on which the vehicle is traveling changed, the processing proceeds to step 310, where the speed limit change flag stored in the internal memory is kept set. When it is not so, the processing proceeds to step 311.

At step 311, when the drive control ECU 13 determines that the vehicle and the other vehicle will come closer than the predetermined distance determining from the steering angle of the steering and the yaw angular velocity received at step 303 and the relative distance to the other vehicle traveling in front of the vehicle and the relative direction to it received at step 305, the drive control ECU 13 directs the alarm 12 to output the alarm tone.

At step 312, the speed signal and the engine speed signal are generated from the travel speed of the vehicle and the engine speed received at step 302, transmitted them to the meter control device 7, and the process is completed.

Here, both when the operation signal is not outputted from the operation switch 11 and when the brake status signal indicating depressing of the brake pedal from the brake pedal switch 53 is not acquired, the operation content determination process at step 306 is skipped.

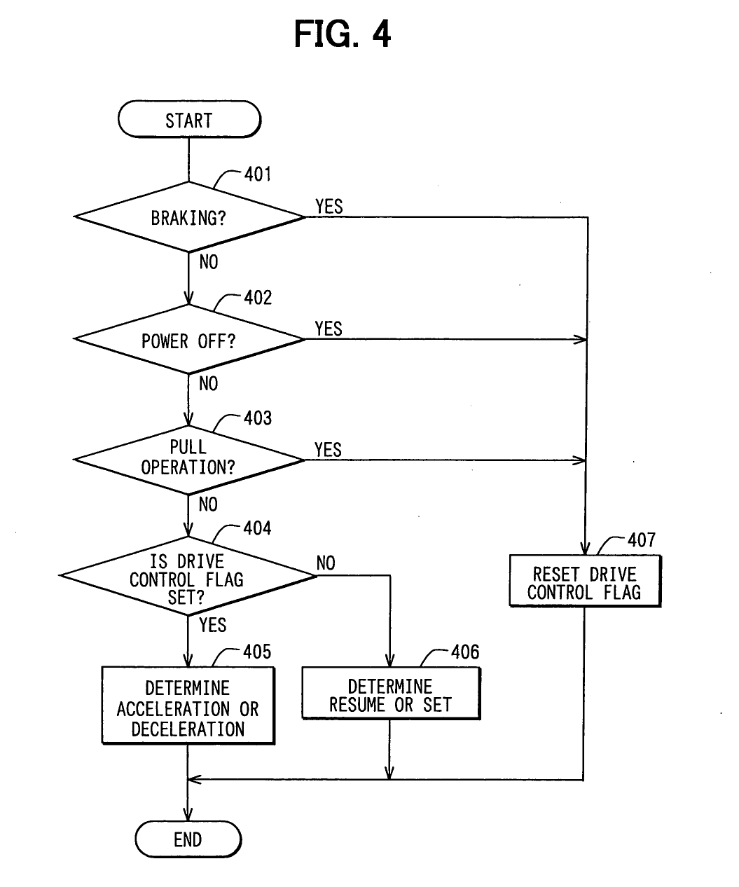

The processing at step 306 is shown in detail in FIG. 4. At step 401, the drive control ECU 13 determines whether the brake pedal was depressed for vehicle braking from the brake status signal received from the vehicle operation detecting device 5. When it is determined that the brake pedal was depressed, the processing proceeds to step 407. When it is not so, the processing proceeds to step 402.

At step 402, whether the operation signal acquired from the operation switch 11 is the power OFF signal is determined. When it is determined to be the power OFF signal, the processing proceeds to step 407. When it is not so, the processing proceeds to step 403.

At step 403, whether the operation signal acquired from the operation switch 11 is the pull operation signal is determined. When it is determined to be the pull operation signal, the processing proceeds to step 407. When it is not so, the processing proceeds to step 404.

At step 404, the drive control flag stored in the internal memory is read, and whether the flag is kept set is determined. When the drive control flag is kept set, the processing proceeds to step 405. When the drive control flag is not being set, the processing proceeds to step 406.

At step 405, when the operation signal acquired from the operation switch 11 is an upward operation signal, the operation content is determined to be the acceleration operation; when it is a downward operation signal, the operation content is determined to be a deceleration operation to reduce the vehicle speed, and the process is completed. On the other hand, at step 406, when the operation signal acquired from the operation switch 11 is an upward operation signal, the operation content is determined to be the resume operation; when it is a downward operation signal, the operation content is determined to be the set operation, and the process is completed.

On the other hand, at step 407, the drive control flag stored in the internal memory is reset, and the process is completed. In addition, in the process of this flowchart, when it is determined that the power OFF signal is acquired at step 402, the power source of the vehicle driving system 1 will be turned off after completing the process of this process.

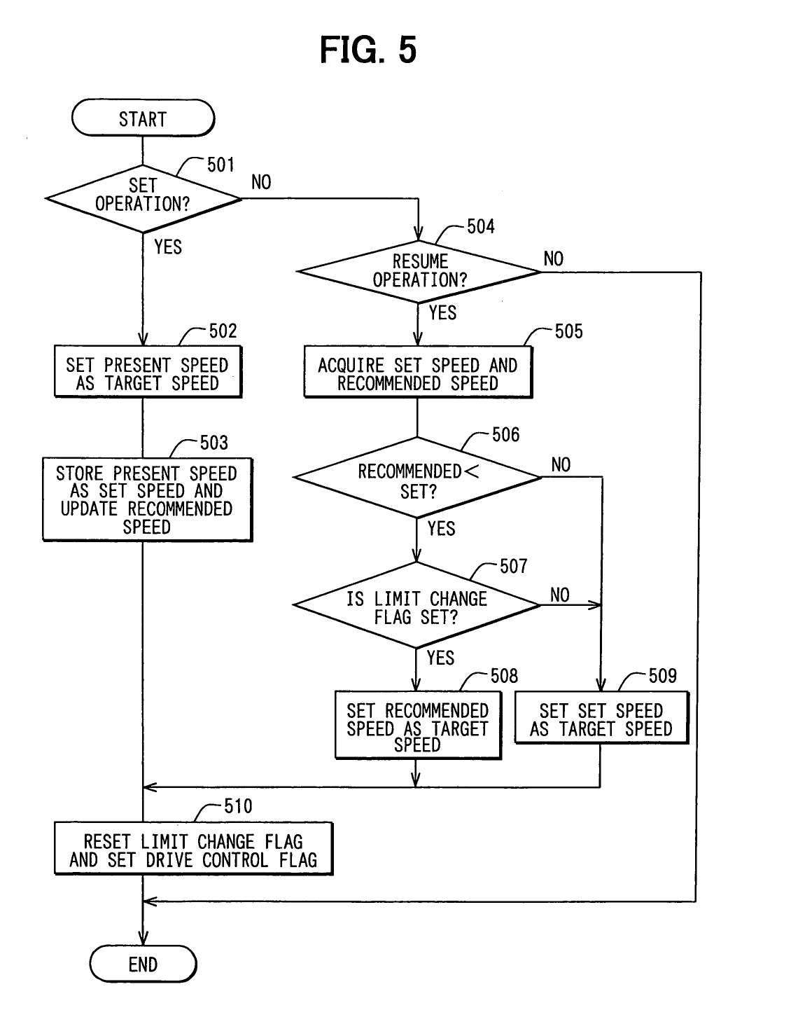

The vehicle driving system 1 sets various settings related to the drive control of the vehicle as shown in FIG. 5. This process is executed when it is determined that the operation content of the operation switch 11 is determined to be the set operation or the resume operation in the process shown in FIG. 4.

At step 501, the drive control ECU 13 checks whether the operation content is the set operation. When it is the set operation, the processing proceeds to step 502. When it is not the set operation, the processing proceeds to step 504.

At step 502, the present travel speed of the vehicle received from the engine control system 4 is set as the target travel speed. At step 503, the travel speed of the vehicle received from the engine control system 4 is stored in the internal memory as the set travel speed. The received travel speed of the vehicle is transmitted to the car navigation apparatus 6. The recommended travel speed of the road on which the vehicle is traveling that is stored in the map data memory 62 is overwritten or updated with the travel speed of the vehicle. Thereby, the travel speed of the vehicle can be assigned to the recommended travel speed of the road on which the vehicle is traveling. Then, the processing proceeds to step 510.

At step 504, whether the operation content is the resume operation is checked. When it is checked as the resume operation, the processing proceeds to step 505. When it is not so, the process is completed.

At step 505, the set travel speed stored in the internal memory and the recommended travel speed transmitted from the car navigation apparatus 6 are acquired. At step 506, the set travel speed and the recommended travel speed that were acquired at step 505 are compared. Then, whether the recommended travel speed is smaller than the set travel speed is determined. When the recommended travel speed is smaller than the set travel speed, the processing proceeds to step 507. When the set travel speed is smaller than the recommended travel speed, the processing proceeds to step 509.

At step 507, the speed limit change flag stored in the internal memory is read, and whether the flag is kept set is determined. When the speed limit change flag is kept set, the processing proceeds to step 508. When it is kept reset, the processing proceeds to step 509.

At step 508, the recommended travel speed acquired at step 505 is set as the target travel speed, and the processing proceeds to step 510. On the other hand, at step 509, the set travel speed acquired at step 505 is set as the target travel speed, and the processing proceeds to step 510.

At step 510, the speed limit change flag stored in the internal memory is reset, the drive control flag similarly stored in the internal memory is set, and the process is completed.

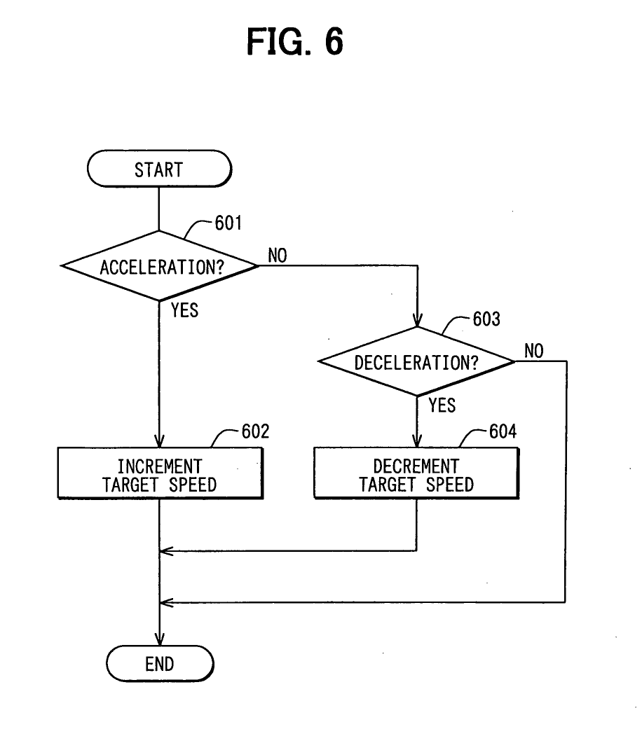

The vehicle driving system 1 adjusts the target travel speed as shown in FIG. 6. This process is executed when it is determined that the operation content of the operation switch 11 is either the acceleration operation or the deceleration operation in the process shown in FIG. 4.

At step 601, the drive control ECU 13 checks whether the operation content is the acceleration operation. When it is the acceleration operation, the processing proceeds to step 602, where the target travel speed is incremented by a predetermined amount, and the process is completed. When it is not the acceleration operation, the processing proceeds to step 603.

At step 603, whether the operation content is a deceleration operation is checked. When it is a deceleration operation, the processing proceeds to step 604, where the target travel speed is decremented by a predetermined amount, and the process is completed. When it is not the deceleration operation, the process is completed. Thereby, the target travel speed can be adjusted during the drive control of the vehicle.

In this way, the vehicle driving system 1, in restarting the drive control of the vehicle in the resume mode, compares the previously stored set travel speed with the recommended travel speed of the road on which the vehicle is traveling, and sets the smaller speed as the target travel speed. Thereby, for example, even if the driver starts or restarts the drive control in the resume mode during ordinary road running due to the driver's misunderstanding or misapprehension after the drive control of the vehicle was performed using the set mode during highway running, when the set travel speed is larger than the recommended speed, the drive control of the vehicle is restarted with the recommended speed. That is, the drive control of a vehicle can be restarted with an appropriate target travel speed.

The process at step 507 is for confirming that a reason of the recommended speed being lower than the set travel speed is a difference between the speed limit of the road on which the drive control executed in the past and the speed limit of the road on which the vehicle is traveling now. Therefore, it may be omitted.

### Second Embodiment

Next, a vehicle driving system 1 according to a second embodiment will be described. In this second embodiment, in starting or restarting the drive control of the vehicle, when the speed limit of a road on which the vehicle is traveling changed compared with the speed limit of a road on which the vehicle performed its drive control last time, the set travel speed of the vehicle or the stored set travel speed is compared with the recommended speed of the road on which the vehicle is traveling. Then the smaller speed is set as the target travel speed.

The drive control ECU 13 in this embodiment checks whether the speed limit change flag stored in the internal memory is kept set in starting or restating the drive control of the vehicle. When the flag is kept set, the drive control ECU 13 compares the travel speed of the vehicle received from the engine control system 4 or the set travel speed stored in the internal memory with the presently recommended travel speed received from the car navigation apparatus 6, sets the smaller speed as the target travel speed, and starts or restarts the drive control of the vehicle. In the case where the speed limit change flag is kept reset, the drive control ECU 13 does not perform the above operations, but starts or restarts the drive control of the vehicle according to the present travel speed of the vehicle received from the engine control system 4 or the set travel speed stored in the internal memory.

Other configurations and operations are the same as those of the first embodiment, and hence their explanations are omitted.

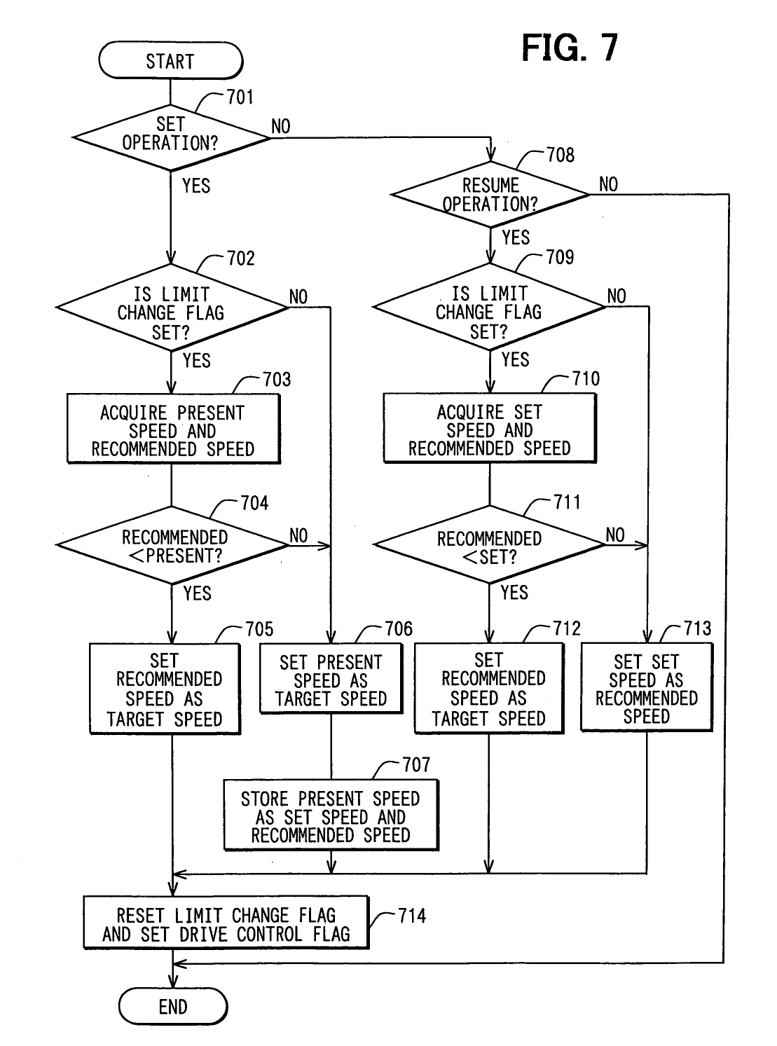

FIG. 7 shows a process in which the vehicle driving system of this embodiment sets various settings related to the drive control of the vehicle. This process is executed when it is determined that the operation content of the operation switch 11 is either the set operation or the resume operation shown in FIG. 4.

At step 701, the drive control ECU 13 checks whether the operation content is the set operation. When it is the set operation, the processing proceeds to step 702. When it is not so, the processing proceeds to step 708.

At step 702, the speed limit change flag stored in the internal memory is read, and whether the flag is kept set is determined. When the speed limit change flag is kept set, the processing proceeds to step 703. When it is kept reset, the processing proceeds to step 706.

At step 703, the travel speed of the vehicle transmitted from the engine control system 4 and the recommended travel speed transmitted from the car navigation apparatus 6 are acquired. At step 704, the travel speed of the vehicle acquired at step 703 is compared with the recommended travel speed to determine whether the recommended travel speed is smaller than the travel speed of the vehicle. When the recommended travel speed is smaller than the set travel speed, the processing proceeds to step 705. When the travel speed of the vehicle is smaller than the recommended travel speed, the processing proceeds to step 706.

At step 705, the recommended travel speed acquired at step 703 is set as the target travel speed, and the processing proceeds to step 714. At step 706, the travel speed of the vehicle acquired at step 703 is set as the target travel speed.

At step 707, the travel speed of the vehicle is stored in the internal memory as the set travel speed, and transmitted to the car navigation apparatus 6, and the recommended travel speed of the road on which the vehicle is traveling that is stored in the map data memory 62 is overwritten with the travel speed of the vehicle. Thereby, the travel speed of the vehicle can be assigned as the recommended travel speed of the road on which the vehicle is traveling. Then, the processing proceeds to step 714.

On the other hand, at step 708, whether the operation content is the resume operation is checked. When it is the resume operation, the processing proceeds to step 709. When it is not so, the process is completed. At step 709, the speed limit change flag stored in the internal memory is read, and whether the flag is kept set is determined. When the speed limit change flag is kept set, the processing proceeds to step 710. When it is kept reset, the processing proceeds to step 713.

At step 710, the set travel speed stored in the internal memory and the recommended travel speed transmitted from the car navigation apparatus 6 are acquired. At step 711, the set travel speed and the recommended travel speed acquired at step 710 are compared, and whether the recommended travel speed is smaller than the set travel speed is determined. When the recommended travel speed is smaller than the set travel speed, the processing proceeds to step 712. When the set travel speed is smaller than the recommended travel speed, the processing proceeds to step 713.

At step 712, the recommended travel speed acquired at step 710 is set as the target travel speed, and the processing proceeds to step 714. At step 713, the set travel speed acquired at step 710 is set as the target travel speed, and the processing proceeds to step 714.

At step 714, the speed limit change flag stored in the internal memory is reset, the drive control flag similarly stored in the internal memory is set, and the process is completed. Thereby, only when the drive control of the vehicle is started or restarted for the first time after the speed limit change flag has been set, it is allowed to compare the travel speed of the vehicle or the set travel speed with the recommended speed and determine the smaller speed as the target travel speed.

In this way, the vehicle driving system of this embodiment checks the status of the speed limit change flag in starting or restarting the drive control of the vehicle in the set mode or in the resume mode. When the flag is kept set, the travel speed of the vehicle or the stored set travel speed is compared with the recommended speed of the road on which the vehicle is traveling, and the smaller speed is set as the target travel speed.

Thereby, when the driver fails to notice that the speed limit of the road on which the vehicle is traveling has changed and starts or restarts the drive control of the vehicle in the set mode or in the resume mode, and when the travel speed of the vehicle or the set travel speed is larger than the recommended speed, the drive control of the vehicle will be started or restarted with the recommended speed. That is, the drive control of the vehicle can be started or restarted with an appropriate target travel speed.

### Third Embodiment

Next, a vehicle driving system 1 in a third embodiment will be described. The vehicle driving system 1 of this embodiment, in starting or restarting the drive control of the vehicle, checks whether the road type (classification) of a road on which the vehicle is traveling differs from the road type of a road on which the vehicle performed its drive control last time. When each road type differs from that of another, the vehicle driving system compares the travel speed of the vehicle or the stored set travel speed with the recommended speed of the road on which the vehicle is traveling, and sets the smaller speed as the target travel speed.

In this embodiment, instead of the speed limit change flag that is set when the speed limit of the road on which the vehicle is traveling changed in the second embodiment described above, a road type change flag that is set when the road type of the road on which the vehicle is traveling changed is provided.

When starting or restarting the drive control of the vehicle in the set mode or in the resume mode, the drive control ECU 13 of this embodiment checks whether the road type change flag stored in the internal memory is kept set. In the case where the flag is kept set, the drive control ECU 13 compares the travel speed of the vehicle received from the engine control system 4 or the set travel speed stored in the internal memory with the recommended speed received from the car navigation apparatus 6, sets the smaller speed as the target travel speed, and starts or restarts the drive control of the vehicle. In the case where the road type change flag is kept reset, the drive control ECU 13 does not perform the above operations, but starts or restarts the drive control of the vehicle according to the travel speed of the vehicle received from the engine control system 4 or the set travel speed stored in the internal memory.

Other configurations and operations are the same as those of the second embodiment described above.

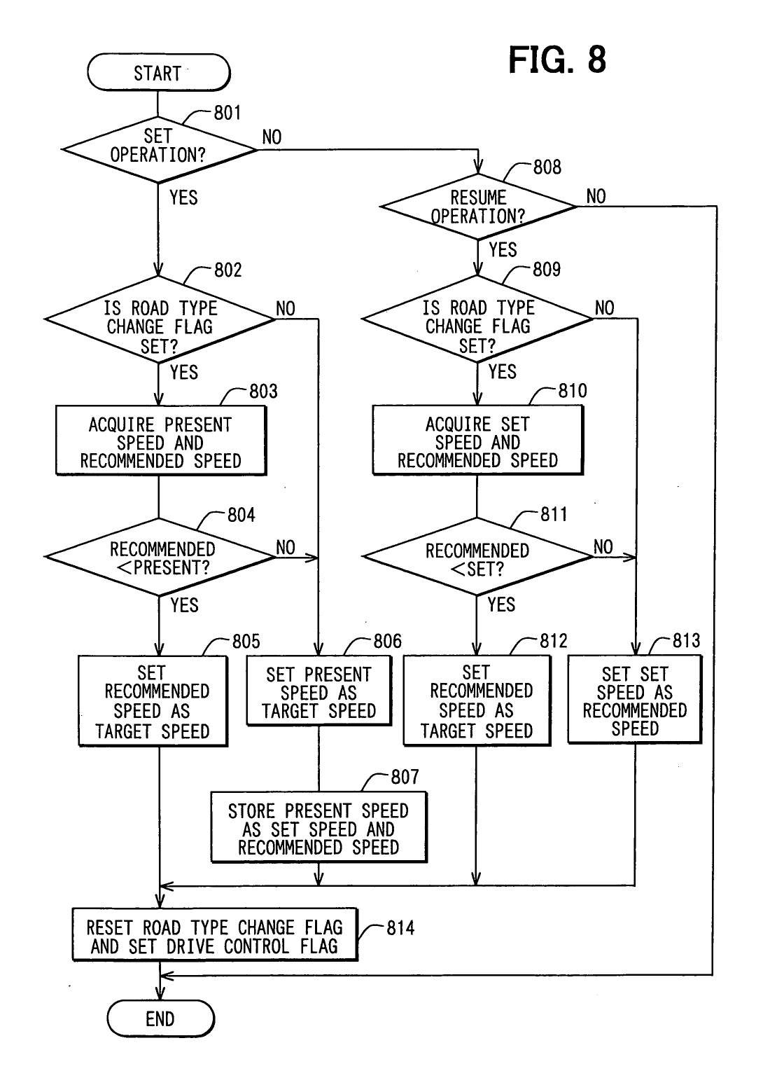

FIG. 8 shows a process of fixing various settings related to the drive control of the vehicle. In this process, a step of determining whether the road type change flag is kept set is provided instead of the step of determining whether the speed limit change flag is kept set in the second embodiment shown in FIG. 7. Moreover, a process of resetting the road type change flag and setting the drive control flag is provided instead of a process of setting the drive control flag. That is, the process steps 801 to 814 except for steps 802, 809 and 814 are the same as those steps 701 to 714 of the process shown in FIG. 7.

At step 802, the drive control ECU 13 reads the road type change flag stored in the internal memory, and determines whether the flag is kept set. When the road type change flag is kept set, the processing proceeds to step 803. When the flag is kept reset, the processing proceeds to step 806.

At step 809, the road type change flag stored in the internal memory is read, and whether the flag is kept set is determined. When the road type change flag is kept set, the processing proceeds to step 810. When the flag is kept reset, the processing proceeds to step 813.

At step 814, the road type change flag stored in the internal memory is reset, the drive control flag stored similarly in the internal memory is set, and the process is completed.

In this way, in the case where the road type change flag is kept set, when the drive control of the vehicle is started or restarted in the set mode or in the resume mode, the vehicle driving system 1 of this embodiment compares the travel speed of the vehicle or the stored set travel speed with the recommended speed of the road on which the vehicle was traveling, and sets the smaller speed as the target travel speed. Thereby, even when the driver starts or restarts the drive control of the vehicle in the set mode or in the resume mode without noticing that the road type of the road on which the vehicle is traveling changed, it is possible to start or restart the drive control of the vehicle with an appropriate target travel speed.

### Fourth Embodiment

Next, a vehicle driving system 1 in a fourth embodiment will be described. The vehicle driving system 1 of this embodiment differs from the second embodiment described above in that, when the drive control of the vehicle is started or restarted within a predetermined time after the speed limit of a road on which the vehicle was traveling changed compared with the speed limit of a road on which the vehicle performed its drive control last time, the vehicle driving system compares the travel speed of the vehicle or the stored set travel speed with the recommended speed of the road on which the vehicle is traveling, and sets the smaller speed as the target travel speed.

The drive control ECU 13 of this embodiment has an internal timer, and activates the internal timer when the speed limit change flag stored in the internal memory is set. In the case where the speed limit change flag is kept set, when starting or restarting the drive control of the vehicle in the set mode or in the resume mode, the drive control ECU 13 reads a value of the internal timer and checks whether the predetermined time has elapsed after the speed limit change flag was set.

When the predetermined time has not yet elapsed, the drive control ECU 13 compares the travel speed of the vehicle received from the engine control system 4 or the set travel speed stored in the internal memory with the recommended speed received from the car navigation apparatus 6, sets the smaller speed as the target travel speed, and starts or restarts the drive control of the vehicle. When the predetermined time has already elapsed, the drive control ECU 13 does not perform the above operations, but starts or restarts the drive control of the vehicle according to the travel speed of the vehicle or the set travel speed stored in the internal memory.

Other configurations and operations are the same as those of the second embodiment described above.

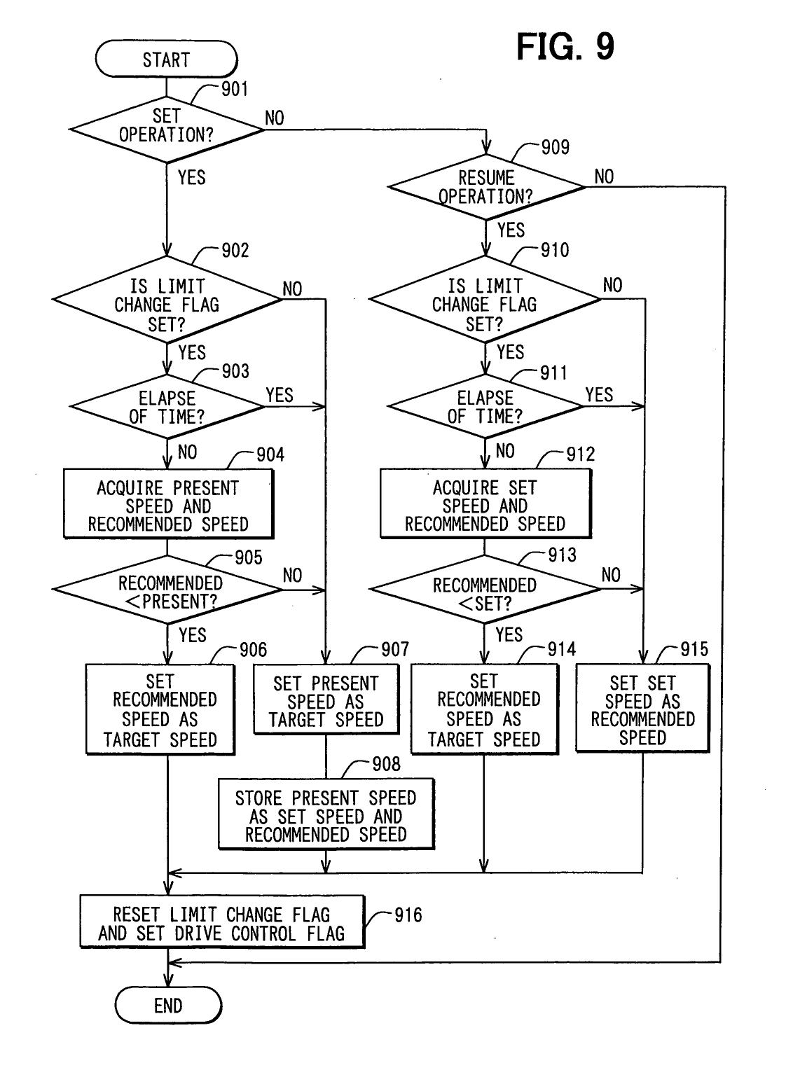

FIG. 9 shows a process in which the vehicle driving system of this embodiment sets various settings related to the drive control of the vehicle. The process in FIG. 9 is similar to the process shown in FIG. 7 to which a step of determining whether a predetermined time has elapsed after setting of the speed limit change flag is newly added. Specifically, the process steps 901 to 916 except for steps 903 and 911 are the same as those steps 701 to 714 of the process shown in FIG. 7.

At step 903, the drive control ECU 13 reads a value of the internal timer, and determines whether the predetermined time has elapsed. When the predetermined time has not yet elapsed, the processing proceeds to step 904. When the predetermined time has already elapsed, the processing proceeds to step 907.

At step 911, the value of the internal timer is read, and whether the predetermined time has elapsed is determined. When the predetermined time has not yet elapsed, the processing proceeds to step 912. When the predetermined time has already elapsed, the processing proceeds to step 915.

In this way, when the drive control of the vehicle is started or restarted in the set mode or in the resume mode within a predetermined time after the speed limit of the road on which the vehicle is traveling changed compared with the speed limit of the road on which the vehicle performed its drive control last time, the vehicle driving system 1 of this embodiment compares the drive control of the vehicle or the stored set travel speed with the recommended speed of the road on which the vehicle is traveling, and sets the smaller speed as the target travel speed. Thereby, even when the driver starts or restarts the drive control of the vehicle immediately after the vehicle left a highway to be on an ordinary road, being conscious as if the vehicle is still traveling on a highway, the drive control of the vehicle can be started or restarted with an appropriate target travel speed.

### Fifth Embodiment

Next, a vehicle driving system 1 in a fifth embodiment will be described. The vehicle driving system 1 of this embodiment differs from the second embodiment in that when the speed limit of a road on which the vehicle is traveling changed compared with the speed limit of a road on which the vehicle performed its drive control last time, measurement of a travel distance of the vehicle is started from that point of time. In the case where the travel distance of the vehicle under measurement is less than a predetermined distance, when the drive control of the vehicle is started or restarted, the vehicle driving system 1 compares the travel speed of the vehicle or the stored set travel speed with the recommended speed of the road on which the vehicle is traveling, and sets the smaller speed as the target travel speed.

The drive control ECU 13 of this embodiment has an internal memory, and when the speed limit stored in the memory is set, the drive control ECU 13 starts to measure a travel distance of the vehicle from that point of time based on the travel speed of the vehicle transmitted from the engine control system 4. The measure travel distance of the vehicle is stored in the internal memory. In the case where the speed limit change flag is kept set, in starting or restarting the drive control of the vehicle in the set mode or in the resume mode, drive control ECU 13 reads a drive distance of the vehicle stored in the internal memory, and checks whether it is larger than a predetermined distance.

When the travel distance of the vehicle is less than a predetermined distance, the drive control ECU 13 compares the set travel speed received from the engine control system 4 or the set travel speed stored in the internal memory with the recommended speed received from the car navigation apparatus 6, sets the smaller speed as the target travel speed, and starts or restarts the drive control of the vehicle. When the travel distance of the vehicle is more than the predetermined distance, the drive control ECU 13 does not perform the above operations, but starts or restarts the drive control of the vehicle according to the travel speed of the vehicle or the set travel speed stored in internal memory.

Other configurations and operations are the same as those of the second embodiment described above.

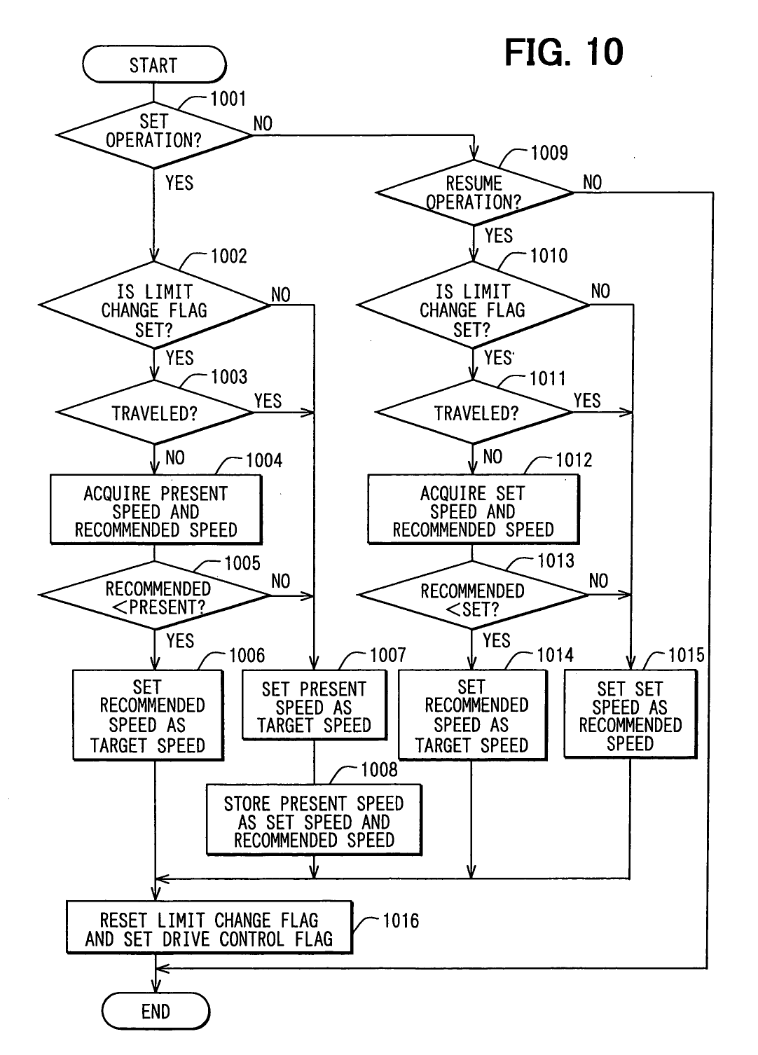

FIG. 10 shows a process in which the vehicle driving system 1 of this embodiment sets various settings related to the drive control of the vehicle. The process shown in FIG. 10 is similar to that of the process shown in FIG. 7 to which a step of determining whether the vehicle traveled a predetermined time after setting of the speed limit change flag is newly added. That is, the process steps 1001 to 1016 except for steps 1003 and 1011 are the same as those steps 701 to 714 of the process shown in FIG. 7.

At step 1003, the drive control ECU 13 reads the travel distance of the vehicle stored in the internal memory, and determines whether the vehicle has traveled the predetermined distance. When the vehicle has not traveled the predetermined distance, the processing proceeds to step 1004. When the vehicle has traveled the predetermined distance, the processing proceeds to step 1007.

At step 1011, the travel distance of the vehicle stored in the internal memory is read, and whether the vehicle has traveled the predetermined distance is determined. When the vehicle has not traveled the predetermined distance or more, the processing proceeds to step 1012. When the vehicle has traveled the predetermined distance, the processing proceeds to step 1015.

In this way, the vehicle driving system 1 of this embodiment, when the speed limit of the road on which the vehicle is traveling changed from the speed limit of the road on which the vehicle performed its drive control last time, measurement of travel distance of the vehicle is started from that point of time. In the case where the travel distance of the vehicle under measurement is less than a predetermined distance, when starting or restarting the drive control of the vehicle, the vehicle driving system compares the travel speed of the vehicle under measurement or a stored set travel speed with the recommended speed of the road on which the vehicle is traveling, and sets the smaller speed as the target travel speed. In this way, the drive control of the vehicle can be started or restarted with an appropriate target travel speed also by measuring the travel distance of the vehicle.

### Sixth Embodiment

Next, a vehicle driving system 1 in a sixth embodiment will be described. The vehicle driving system 1 of this embodiment, in restarting the drive control of the vehicle in the resume mode, determines whether the road attributes of a road on which the vehicle is traveling, such as road type and a speed limit, differ from the road attributes of the road on which the vehicle performed its drive control in the past. Moreover, the vehicle driving system 1 is characterized in that, when it is determined that the road attributes are different, the restart of the drive control in the resume mode is prohibited.

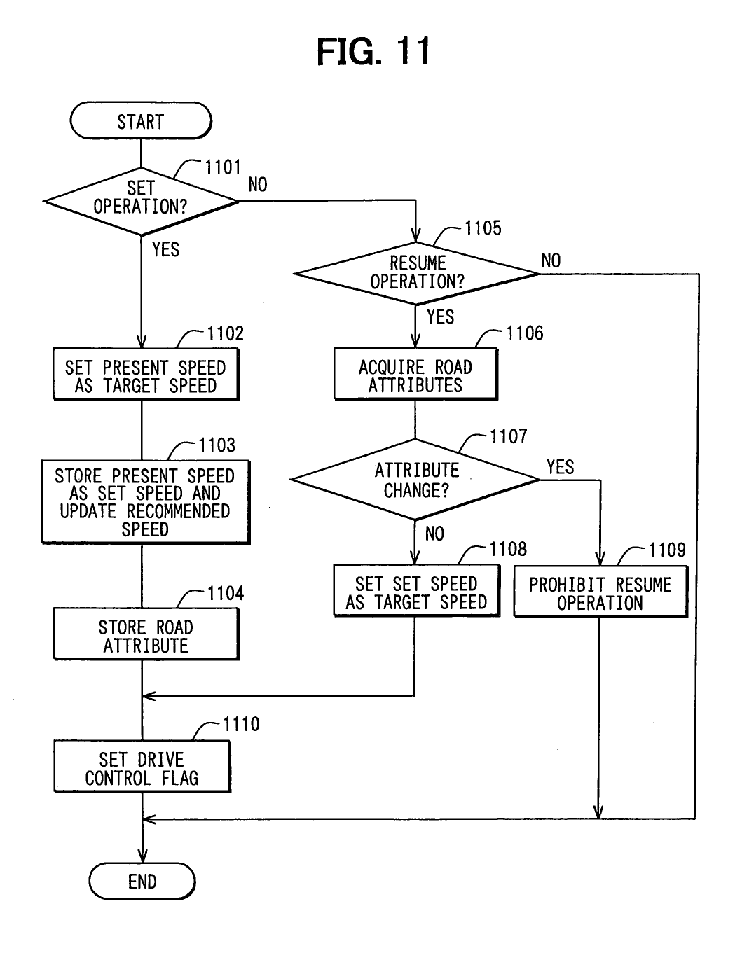

FIG. 11 shows a process in which the vehicle driving system 1 of this embodiment sets various settings related to the drive control of the vehicle. Process steps 1101-1103 are the same as those of steps 501-503 in the first embodiment (FIG. 5). However, instead of the process steps 501-503 in the first embodiment, any process selected among the process steps 701-707 in the second embodiment, the process steps 801-807 in the third embodiment, the process steps 901-908 in the third embodiment, and the processes steps 1001-1008 in the fifth embodiment may be used.

When the set travel speed is stored at step 1103, the road attributes of the road on which the vehicle is traveling at the time of storing the set travel speed is acquired from the car navigation apparatus 6 and stored at step 1104. The road attributes stored at this time include at least one of a speed limit of the road, road type, a width of the road and the numbers of lanes.

On the other hand, when it is determined that the set operation is not done at step 1101 and that the resume operation is done at step 1105, the processing proceeds to step 1106. At step 1106, at the time when the resume operation is done, the road attributes of the road on which the vehicle is traveling are acquired from the car navigation apparatus 6.

In the following step 1107, the road attributes stored at step 1104 are compared with the road attributes acquired at step 1106, and whether any change has arisen between the both is determined. In this determination process, when it is determined that the road attributes are not changed, the processing proceeds to step 1108, where the stored set travel speed is set as the target travel speed. Subsequently, at step 1110, the drive control flag stored in the internal memory is set, and the process is completed.

On the other hand, when it is determined that the road attributes changed at step 1107, the processing proceeds to step 1109, where the restart of the drive control by the resume operation is prohibited. For example, in this prohibition process, the resume operation is made invalid and a warning that the restart of the drive control by the resume operation cannot be done is sent out.

For example, the set travel speed stored during traveling on a highway is very likely to be inappropriate as the target travel speed on an ordinary road. In this way, it is highly likely that, when at least one of a speed limit, road type, a road width, and the number of lanes that constitute road attributes changes, an appropriate target speed may change.

Therefore, this embodiment stores the road attributes of the road on which the vehicle is traveling at the time of storing the set travel speed, and compares them with the road attributes of the road on which the vehicle was traveling when the resume operation was done. Then, when it is determined that the road attributes have changed, the restart of the drive control by the resume operation is prohibited. Thereby, an inappropriate target travel speed can be prevented from being set based on the set travel speed by the resume operation.

As described above, in this embodiment, the road attributes during traveling are stored at the time of storing the set travel speed, and compared with the road attributes during traveling at the time when the resume operation is done, whereby a change in the road attributes is determined. Therefore, in this embodiment, it is unnecessary to use the speed limit change flag unlike the first embodiment that requires its use. However, naturally it is possible to determine a change in the road attributes using the speed limit change flag or the road type change flag as in the cases of the above embodiments.

Conversely, in the above embodiments, it is also possible to store the road attributes at the time of the last drive control, as in the sixth embodiment, and determine whether the road attributes, such as a speed limit and road type, changed by comparing the last-time road attributes with the road attributes when the set operation or resume operation is done. Further, only one road attribute may be acquired to determine change of roads.

In the foregoing embodiments, the travel speed of the vehicle is set as the target travel speed in starting the drive control of the vehicle in the set mode. However, the above target travel speed may be fixed to a travel speed specified by a remote controller, etc.

Moreover, in the foregoing embodiments, when the travel speed of the vehicle is set as the target travel speed in the set mode, the recommended speed of the road on which the vehicle is traveling that is stored in the map data memory 62 is overwritten with the travel speed of the vehicle. However, the travel speed of the vehicle may be simply stored without overwriting the recommended speed of the road on which the vehicle is traveling. Thereby, it becomes possible to set the target travel speed considering also the travel speed of the vehicle that was set as the target travel speed in the past in restarting the drive control of the vehicle in the resume mode the next time and later rounds.

In the foregoing embodiments, in starting or restarting the drive control of the vehicle in the set mode or in the resume mode, the drive control of a vehicle is made to start or restart with an appropriate target travel speed. However, the drive control of a vehicle may be started or restarted so that an appropriate distance between vehicles is maintained. The drive control of a vehicle may be started or restarted by controlling an appropriate target travel speed and a distance between vehicles.

Other modifications and alterations are also possible to the above embodiments without departing from the spirit of the present invention.

1. A vehicle driving system for a vehicle having at least two operation modes that includes a set mode of setting a target speed and starting drive control of the vehicle according to the target speed and a resume mode of restarting the drive control of the vehicle according to the target speed set in the set mode, the vehicle driving system comprising:
recommended travel speed acquiring means for acquiring a recommended travel speed that is recommended in a road on which the vehicle is traveling; and
setting means that, in restarting the drive control of the vehicle in the resume mode, compares the target speed set in the set mode with the recommended speed acquired by the recommended travel speed acquiring means, and sets a smaller speed as the target speed used for performing the drive control of the vehicle.

2. The vehicle driving system according to claim 1, further comprising:
storage means for storing travel speeds recommended for respective roads in urban areas so that the recommended travel speed acquiring means acquires the recommended travel speed for each road; and
rewriting means that identifies the road on which the vehicle is traveling when the target speed is set in the set mode and overwrites the travel speed that is recommended for the road and stored in the storage means with the target speed being set.

3. The vehicle driving system according to claim 1, further comprising:
altering means for altering the target speed set by the setting means during the drive control of the vehicle.

4. A vehicle driving system for a vehicle having at least two operation modes that includes a set mode of setting a target speed and starting drive control of the vehicle according to the target speed and a resume mode of restarting the drive control of the vehicle according to the target speed set in the set mode, the vehicle driving system comprising:
acquiring means for acquiring a road attribute including a recommended travel speed that is recommended in a road on which the vehicle is traveling; and
setting means that, in a case where a road attribute of a road on which the vehicle was traveling when the drive control of the vehicle was performed last time differ from a road attribute of a road on which the vehicle is traveling when the drive control of the vehicle is started or restarted this time, compares the target travel speed being set or the target travel speed having been set in the set mode with the recommended travel speed included in the road attribute acquired by the acquiring means, and sets a smaller speed as the target travel speed used for performing the drive control of the vehicle.

5. The vehicle driving system according to claim 4, wherein the setting means has a road-attribute change flag that will be set when the road attribute acquired by the acquiring means changed and determines a difference in the road attributes based on the road-attribute change flag.

6. The vehicle driving system according to claim 5, wherein the setting means sets the target travel speed when the drive control of the vehicle is started or restarted for the first time after the road-attribute change flag was set.

7. The vehicle driving system according to claim 5, wherein the setting means sets the target travel speed when the drive control of the vehicle is started or restarted during a predetermined period from a time point of setting the road-attribute change flag or during a period when the vehicle travels a predetermined distance.

8. The vehicle driving system according to claim 4, wherein the road attribute acquired by the acquiring means is a speed limit of the road on which the vehicle is traveling.

9. The vehicle driving system according to claim 4, wherein the road attribute acquired by the acquiring means is a road type of the road on which the vehicle is traveling.

10. The vehicle driving system according to claim 4, further comprising:
storage means for storing travel speeds recommended for respective roads in urban areas so that the recommended travel speed acquiring means acquires the recommended travel speed for each road; and
rewriting means that identifies the road on which the vehicle is traveling when the target speed is set in the set mode and overwrites the travel speed that is recommended for the road and stored in the storage means with the target speed being set.

11. The vehicle driving system according to claim 4, further comprising:
altering means for altering the target speed set by the setting means during the drive control of the vehicle.

12. A vehicle driving system for a vehicle having at least two operation modes that includes a set mode of setting a target speed and starting drive control of the vehicle according to the target speed and a resume mode of restarting the drive control of the vehicle according to the target speed set in the set mode, the vehicle driving system comprising:
acquiring means for acquiring a road attribute of a road on which the vehicle is traveling; and
prohibiting means that prohibits a restart of the drive control of the vehicle, when the road attribute of a road on which the vehicle was traveling when the drive control of the vehicle was executed in the set mode differ from the road attribute of the road on which the vehicle is traveling when the drive control of the vehicle is restarted in the resume mode.

13. The vehicle driving system according to claim 12, wherein the road attribute is at least one of a speed limit, road type, a road width and number of lanes.

14. A vehicle driving method for a vehicle comprising:
setting a target travel speed upon instruction from a driver;
starting drive control of the vehicle to automatically attain the target travel speed; and
resuming the drive control of the vehicle to automatically attain the target travel speed upon instruction from the driver after the step of starting drive control is terminated once,
wherein the step of resuming includes steps of
acquiring a predetermined attribute of a road on which the drive control is to be resumed,
checking, based on the predetermined attribute, whether the target travel speed is appropriate for resuming the drive control on the road, and
lowering the target travel speed when the checking step determines that the target travel speed is in appropriate.

15. The vehicle driving method according to claim 14, wherein the step of acquiring acquires the predetermined attribute from a navigation system mounted in the vehicle.

16. The vehicle driving method according to claim 14, wherein the predetermined attribute includes at least one of a speed limit, road type, road width and number of lanes.
